(19) United States
(12) Patent Application Publication
(10) Pub. No.: US 2004/0073421 A1
(43) Pub. Date: Apr. 15, 2004

(54) Method and device for encoding wideband speech capable of independently controlling the short-term and long-term distortions

(75) Inventors: Michael Ansorge, Hauterive (CH); Giuseppina Biundo Lotito, Neuchatel (CH); Benito Carnero, Santa Clara, CA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics N.V., Amsterdam (NL)

(21) Appl. No.: 10/622,019

(22) Filed: Jul. 17, 2003

(30) Foreign Application Priority Data
Jul. 17, 2002 (EP) 02015919.0

(51) Int. Cl. G10L 19/10

(52) U.S. Cl. 704/219

(57) ABSTRACT

A method for encoding wideband speech includes sampling the speech to obtain successive voice frames each comprising a predetermined number of samples, and determining for each voice frame parameters of a linear prediction model. The parameters include a long-term excitation word extracted from an adaptive coded directory, and a short-term excitation word extracted from a fixed coded directory. The extraction of the long-term excitation word is performed using a first weighting filter. The extraction of the short-term excitation word is performed using a second weighting filter cascaded with a third weighting filter. The first and third weighting filters are equal.

### FIELD OF THE INVENTION

The present invention relates to the encoding/decoding of wideband speech, and in particular, with respect to mobile telephony.

### BACKGROUND OF THE INVENTION

In wideband speech, the bandwidth of the speech signal lies between 50 and 7,000 Hz. Successive speech sequences sampled at a predetermined sampling frequency, for example 16 kHz, are processed in a coding device of the CELP type using coded-sequence-excited linear prediction. For example, one such device is referred to as ACELP, which stands for algebraic code excited linear prediction. This device is well known to one skilled in the art, and is described in recommendation ITU-TG 729, version 3/96, entitled “Coding Of Speech At 8 kbits/s By Conjugate Structure-Algebraic Coded Sequence Excited Linear Prediction”.

The main characteristics and functions of such a coder will now be briefly discussed while referring to FIG. 1. Further details may be found in the above mentioned recommendation.

The prediction coder CD of the CELP type is based on the model of code-excited linear predictive coding. The coder operates on voice super-frames equivalent to 20 ms of signal for example, and each comprises 320 samples. The extraction of the linear prediction parameters, that is, the coefficients of the linear prediction filter which is also referred to as the short-term synthesis filter 1/A(z), is performed for each speech super-frame. Each super-frame is subdivided into frames of 5 ms comprising 80 samples. For every frame, the voice signal is analyzed to extract therefrom the parameters of the CELP prediction model.

In particular, the extracted parameters include a long-term excitation digital word vᵢ extracted from an adaptive coded directory also referred to as an adaptive long-term dictionary LTD, an associated long-term gain Ga, a short-term excitation word cⱼ extracted from a fixed coded directory also referred to as a short-term dictionary STD, and an associated short-term gain Gc.

These parameters are thereafter coded and transmitted. At reception, these parameters are used in a decoder to recover the excitation parameters and the predictive filter parameters. The speech is then reconstructed by filtering the excitation stream in a short-term synthesis filter.

The adaptive dictionary LTD contains digital words representative of tonal lags representative of past excitations. The short-term dictionary STD is based on a fixed structure, for example of the stochastic type or of the algebraic type, using a model involving an interleaved permutation of Dirac pulses. In the case of an algebraic structure, the coded directory contains innovative excitations also referred to as algebraic or short-term excitations. Each vector contains a certain number of non-zero pulses, for example four, each of which may have the amplitude +1 or −1 with predetermined positions.

The processing means of the coder CD functionally comprises first extraction means MEXT 1 for extracting the long-term excitation word, and second extraction means MEXT 2 for extracting the short-term excitation word. Functionally, the extraction means MEXT 1 and MEXT 2 are embodied in software within a processor for example.

The extraction means MEXT 1 and MEXT 2 each comprise a predictive filter PF having a transfer function equal to 1/A(z), as well as a perceptual weighting filter PWF having a transfer function W(z). The perceptual weighting filter PWF is applied to the signal to model the perception of the ear. Furthermore, the extraction means MEXT 1 and MEXT 2 each comprise means MSEM for performing a minimization (i.e., a reduction) of a mean square error.

The synthesis filter PF of the linear prediction models the spectral envelope of the signal. The linear prediction analysis is performed every super-frame to determine the linear predictive filtering coefficients. The latter are converted into pairs of spectral lines, i.e., line spectrum pairs LSP and are digitized by predictive vector quantization in two steps.

Each 20 ms a speech super-frame is divided into four frames of 5 ms each containing 80 samples. The quantized LSP parameters are transmitted to the decoder once per super-frame, whereas the long-term and short-term parameters are transmitted at each frame.

The quantized and non-quantized coefficients of the linear prediction filter are used for the most recent frame of a super-frame, while the other three frames of the same super-frame use an interpolation of these coefficients. The open-loop tonal lag is estimated, for example every two frames on the basis of the perceptually weighted voice signal. The following operations are repeated at each frame.

The long-term target signal X_{LT} is calculated by filtering the sampled speech signal s(n) by the perceptual weighting filter PWF. The zero-input response of the weighted synthesis filters PF and PWF is thereafter subtracted from the weighted voice signal to obtain a new long-term target signal. The impulse response of the weighted synthesis filter is calculated.

A closed-loop tonal analysis using minimization or reduction of the mean square error is thereafter performed to determine the long-term excitation word vᵢ and the associated gain Ga by the target signal and of the impulse response, and by searching around the value of the open-loop tonal lag.

The long-term target signal is thereafter updated by subtraction of the filtered contribution y of the adaptive coded directory LTD. This new short-term target signal X_{ST} is used during the exploration of the fixed coded directory STD to determine the short-term excitation word cⱼ and the associated gain G_{c}. Here again, this closed-loop search is performed by minimization of the mean square error.

The adaptive long-term dictionary LTD as well as the memories of the filters PF and PWF are updated by the long-term and short-term excitation words thus determined. The quality of a CELP algorithm depends strongly on the richness of the short-term excitation dictionary STD, for example an algebraic excitation dictionary. Even though the effectiveness of such an algorithm is very high for narrow bandwidth signals (300-3,400 Hz), problems arise with respect to wideband signals.

### SUMMARY OF THE INVENTION

In view of the foregoing background, an object of the present invention is to independently control the short-term and long-term distortions associated with the encoding/decoding of wideband speech.

This and other objects, advantages and features in accordance with the present invention are provided by a wideband speech encoding method in which the speech is sampled to obtain successive voice frames. Each voice frame comprises a predetermined number of samples, and with each voice frame are determined parameters of a code-excited linear prediction model. These parameters comprise a long-term excitation digital word extracted from an adaptive coded directory, as well as a short-term excitation word extracted from an associated fixed coded directory.

According to a general characteristic of the invention, the extraction of the long-term excitation word is performed using a first perceptual weighting filter comprising a first formantic weighting filter. The extraction of the short-term excitation word is performed using the first perceptual weighting filter cascaded with a second perceptual weighting filter comprising a second formantic weighting filter. The denominator of the transfer function of the first formantic weighting filter is equal to the numerator of the second formantic weighting filter.

According to the invention, the use of two different formantic weighting filters makes it possible to control the short-term and the long-term distortions independently. The short-term weighting filter is cascaded with the long-term weighting filter. Furthermore, the tying of the denominator of the long-term weighting filter to the numerator of the short-term weighting filter makes it possible to control these two filters separately, and allows a significant simplification when these two filters are cascaded.

Another aspect of the present invention is directed to a wideband speech encoding device comprising sampling means for sampling the speech to obtain successive voice frames, each comprising a predetermined number of samples. Processing means determine parameters of a code-excited linear prediction model for each voice frame. The processing means comprises first extraction means for extracting a long-term excitation digital word from an adaptive coded directory, and second extraction means for extracting a short-term excitation word from a fixed coded directory.

According to a general characteristic of the invention, the first extraction means comprises a first perceptual weighting filter comprising a first formantic weighting filter, the second extraction means comprise the first perceptual weighting filter and a second perceptual weighting filter comprising a second formantic weighting filter. The denominator of the transfer function of the first formantic weighting filter is equal to the numerator of the second formantic weighting filter.

Yet another aspect of the present invention is directed to a terminal of a wireless communication system, such as a cellular mobile telephone for example, incorporating a device as defined above.

### BRIEF DESCRIPTION OF THE DRAWINGS

Other advantages and characteristics of the invention will become apparent on examining the detailed description of embodiments and modes of implementation, which are in no way limiting, and the appended drawings, in which:

FIG. 1 diagrammatically illustrates a speech encoding device according to the prior art;

FIG. 2 diagrammatically illustrates an embodiment of an encoding device according to the present invention; and

FIG. 3 diagrammatically illustrates the internal architecture of a mobile cell telephone incorporating a coding device according to the present invention.

### DETAILED DESCRIPTION OF THE PREFERRED EMBODIMENTS

The perceptual weighting filter PWF utilizes the masking properties of the human ear with respect to the spectral envelope of the speech signal. The shape of the envelope depends on the resonances of the vocal tract. This filter makes it possible to attribute more importance to the error appearing in the spectral valleys as compared with the formantic peaks.

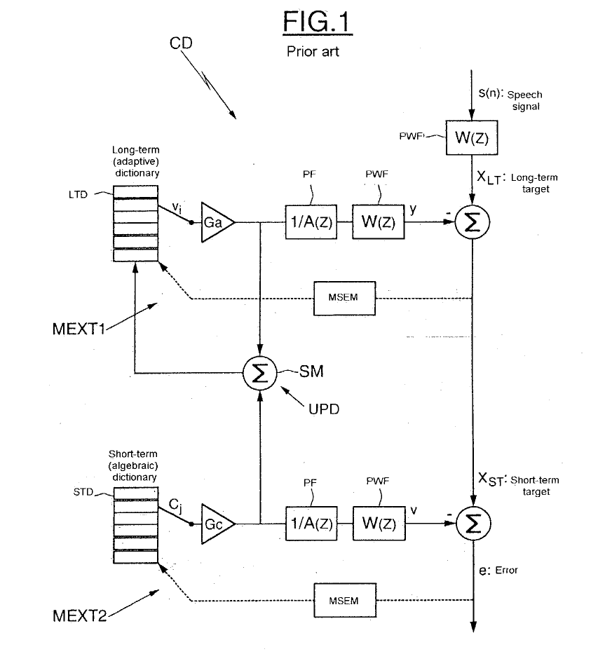

In the prior art illustrated in FIG. 1, the same perceptual weighting filter PWF is used for the short-term and long-term search. The transfer function W(z) of this filter PWF is given by the formula (I) below:

$$W ( z ) = \frac{A ( z / {γ}_{1} )}{A ( z / {γ}_{2} )} \qquad ( I )$$

in which 1/A(z) is the transfer function of the predictive filter PF, and γ1 and γ2 are the perceptual weighting coefficients. The two coefficients are positive or zero and less than or equal to 1, with the coefficient γ2 being less than or equal to the coefficient γ1.

In a general manner, the perceptual weighting filter PWF is constructed from a formantic weighting filter and from a filter for weighting the slope of the spectral envelope of the signal (tilt). In the present case, it will be assumed that the perceptual weighting filter PWF is formed only from the formantic weighting filter whose transfer function is given by formula (I) above.

The spectral nature of the long-term contribution is different from that of the short-term contribution. Consequently, it is advantageous to use two different formantic weighting filters. This makes it possible to control the short-term and long-term distortions independently.

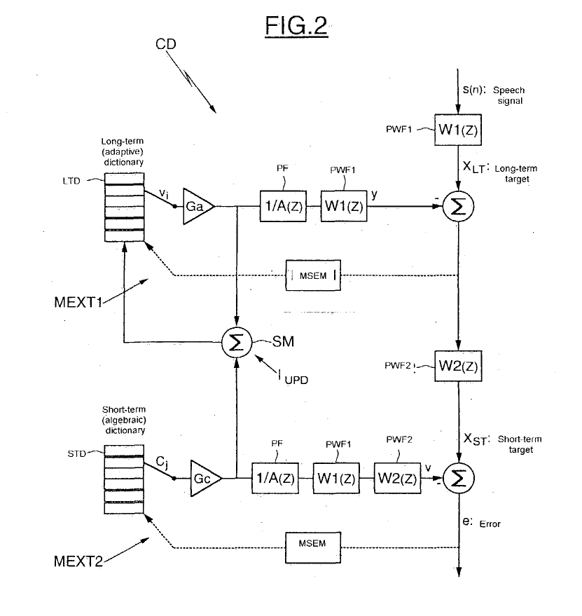

Such an embodiment according to the invention is illustrated in FIG. 2, in which, as compared with FIG. 1, the single filter PWF has been replaced by a first formantic weighting filter PWF1 for the long-term search, cascaded with a second formantic weighting filter PWF2 for the short-term search. Since the short-term weighting filter PWF2 is cascaded with the long-term weighting filter, the filters appearing in the long-term search loop must also appear in the short-term search loop.

The transfer function W₁(z) of the formantic weighting filter PWF1 is given by formula (II) below:

$${W}_{1} ( z ) = \frac{A ( z / {γ}_{11} )}{A ( z / {γ}_{12} )} \qquad ( II )$$

whereas the transfer function W₂(z) of the formantic weighting filter PWF2 is given by formula (III) below:

$${W}_{2} ( z ) = \frac{A ( z / {γ}_{21} )}{A ( z / {γ}_{22} )} \qquad ( III )$$

The coefficient γ₁₂ is equal to the coefficient γ₂₁. This allows a significant simplification when these two filters are cascaded. Thus, the filter equivalent to the cascade of these two filters has a transfer function given by the formula (IV) below:

$$\frac{A ( z / {γ}_{11} )}{A ( z / {γ}_{22} )} \qquad ( IV )$$

If one uses the value 1 for the coefficient γ₁₁, then the synthesis filter PF having the transfer function 1/A(z) followed by the long-term weighting filter PWF1 and by the weighting filter PWF2 is then equivalent to the filter whose transfer function is given by the formula (V) below:

$$\frac{1}{A ( z / {γ}_{22} )} \qquad ( V )$$

This further considerably reduces the complexity of the algorithm for extracting the excitations. By way of illustration, for example, it is possible to use the respective values 1, 0.1 and 0.9 for the coefficients γ₁₁, γ₂₁=γ₁₂ and γ₂₂.

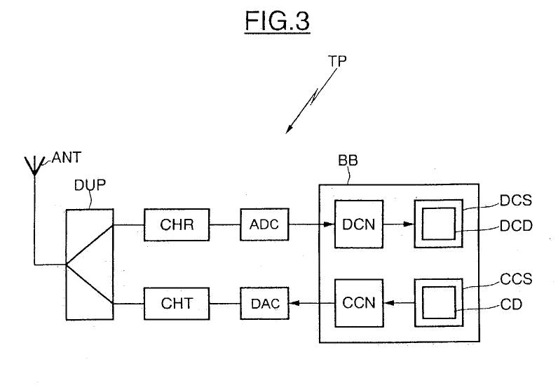

The invention applies advantageously to mobile telephones, and in particular, to remote terminals belonging to a wireless communication system. Such a terminal, for example a mobile telephone TP, such as illustrated in FIG. 3, conventionally comprises an antenna linked by way of a duplexer DUP to a reception chain CHR and to a transmission chain CHT. A baseband processor BB is linked respectively to the reception chain CHR and to the transmission chain CHT by an analog-to-digital converter ADC and by a digital-to-analog converter DAC.

Conventionally, the processor BB performs baseband processing, and in particular, a channel decoding DCN, followed by a source decoding DCS. For transmission, the processor performs a source coding CCS followed by a channel coding CCN. When the mobile telephone incorporates a coder according to the invention, the latter is incorporated within the source coding means CCS, whereas the decoder is incorporated within the source decoding means DCS.

That which is claimed is:

1. Wideband speech encoding method in which the speech is sampled in such a way as to obtain successive voice frames each comprising a predetermined number of samples, and with each voice frame are determined parameters of a code-excited linear prediction model, these parameters comprising a long-term excitation digital word extracted from an adaptive coded directory as well as a short-term excitation word extracted from a fixed coded directory, characterized in that the extraction of the long-term excitation word is performed using a first perceptual weighting filter comprising a first formantic weighting filter (PWF1), in that the extraction of the short-term excitation word is performed using the first perceptual weighting filter (PWF1) cascaded with a second perceptual weighting filter comprising a second formantic weighting filter (PWF2), and in that the denominator of the transfer function of the first formantic weighting filter is equal to the numerator of the second formantic weighting filter.

2. Wideband speech encoding device comprising sampling means able to sample the speech in such a way as to obtain successive voice frames each comprising a predetermined number of samples, processing means able with each voice frame, to determine parameters of a code-excited linear prediction model, these processing means comprising first extraction means able to extract a long-term excitation digital word from an adaptive coded directory, and second extraction means able to extract a short-term excitation word from a fixed coded directory, characterized in that the first extraction means (MEXT1) comprise a first perceptual weighting filter comprising a first formantic weighting filter (PWF1), in that the second extraction means (MEXT2) comprise the first perceptual weighting filter cascaded with a second perceptual weighting filter comprising a second formantic weighting filter (PWF2), and in that the denominator of the transfer function of the first formantic weighting filter is equal to the numerator of the second formantic weighting filter.

3. Terminal of a wireless communication system, characterized in that it incorporates a device according to claim 2.

4. Terminal according to claim 3, characterized in that it forms a cellular mobile telephone.
